(19) United States
(12) Patent Application Publication
(10) Pub. No.: US 2024/0035270 A1
(43) Pub. Date: Feb. 1, 2024

(54) A CONNECTOR

(71) Applicant: Geon Yapisal Teknolojiler, Uskudar/Istanbul (TR)

(72) Inventor: Devrim Pacaci, Beyoglu/Istanbul (TR)

(21) Appl. No.: 18/268,039

(22) PCT Filed: Dec. 22, 2020
(86) PCT No.: PCT/TR2020/051346

§ 371 Date: Jun. 16, 2023

(51) Int. Cl. E04B 1/19; F16B 7/18

(52) U.S. Cl. CPC E04B 1/1903; F16B 7/185; E04B 2001/196

(57) ABSTRACT

This invention is about a connector, connecting bars and components, like panels and braces, in a supporting framework. The connector has a holder, having a first and a second end, the first end, connected to the connector, the second end, connected to the framework component. The connector comprises a plurality of faces, each adapted to be connected to one bar, the faces located in a corresponding plurality of faces of an imaginary polyhedron.

### 1. TECHNICAL FIELD

This invention relates to a connector, connecting bars and components, like panels and braces, in a supporting framework.

### 2. BACKGROUND ART

A truss is an assembly of bars that are connected to each other to form a rigid structure. A particular type of a truss system has been developed, in which, a component, referred as a connector, is used to connect bars. A connector is a component, usually in the form of a polyhedron, with faces that the ends of the bars are connected to. A simple pin-joint connection is sufficient for most cases for that connection, because the truss systems are designed to be subjected only to axial forces. In those systems, other framework components including panels or cross braces are also connected to the connectors by means of holders, which are in the form of arms, having an end connected to the connector and another end connected to the framework components. Trusses with various forms of connectors have been developed and used so far in a wide range of areas, including, temporary and permanent building structures, building facades and roofs, trade fair stands and booths, office furniture, walls and various fit-out components.

Documents US2008175655 and U.S. Pat. No. 9,163,390B2 shows connectors with a specific type, with cavities, formed in between the faces. Document US2008175655 suggests a connector, having a pair of extensions in the form of arms on a peripheral edge of each face of the connector, to form loops, wherein a holder with a hook-shaped end, is received and retained therein. This embodiment introduces a simple and easy, but a loose connection for the holder, making it prone to unwanted dislocations. In cases, when the holder is connected to a panel, the unstable position of the holder causes misalignment problems for the panel.

In U.S. Pat. No. 9,163,390B2, another connector is suggested with at least two bars connected to an adjacent couple of the faces of the connector and the problem of the loose connection of the holder, is solved by an improved design, such that, when the holder is connected to the connector, the end of the holder that the framework component is connected to, comes into a contacting position with the proximal portions of the adjacent couple of the bars and shaped in a manner substantially enclosing that proximal portions, stabilizing the holder in the plane formed for the two bars.

However, this embodiment causes a slight but undesired enlargement of the holder, at the second end. Further, the holders cannot be stabilized in cases when adjacent bars that stabilize the holder are absent. This is common for connectors at the corners of the truss assemblies. Absence of even one of the bars severely worsens the stabilization. Similar problem occurs in cases with adjacent bars with different cross section sizes. It is also common in truss systems, that, different sized bars are connected to the same connector. Designing different holders for each bar configuration to be able to achieve a similar stabilizing effect, would be an option, but definitely with an additional cost and complexity, which are not economical for most cases.

Therefore, the aim of our invention is to suggest an improved connector, obviating the disadvantages of the prior art connectors.

### 3. DISCLOSURE OF THE INVENTION

For the purposes I stated above and in accordance with the invention, I suggest a connector and at least one holder, to be used with a plurality of bars and at least one framework component, in a supporting framework, the framework component, selected from a group, consisting of at least one cross brace, at least one panel and combinations thereof, the holder, having a first and a second end, the first end, connected to the connector, the second end, connected to at least one of the framework components, the connector, comprising, a plurality of faces, each adapted to be connected to one bar, the faces located in a corresponding plurality of faces of an imaginary polyhedron, the connector further comprising an inner core and a plurality of receiving plates, the inner core, located in between the faces of the connector, the inner core comprising projections, each projecting toward one of the faces, each of the receiving plates, located between an adjacent couple of the projections of the inner core and connected thereto, lying parallel to an imaginary plane that passes through the longitudinal axis of each of the projections of the adjacent couple thereof, and the receiving plates, the inner core and the projections thereof, together, defining cavities, inside the imaginary polyhedron, at each corner thereof, the first end of the holder, located in a cavity, connected to the corresponding receiving plate, the connector and the holder, characterized in that, the first end of the holder, is shaped so as to adjust to the corresponding portion of the cavity, such that, when located properly, the first end of the holder is encased in the cavity, in a way, stabilizing the second end thereof, in its final position.

The cavities and holders can be shaped in relation with each other, such that, a holder per each receiving plate can be connected to the connector, concurrently. Preferably, each of the receiving plates has a hole and the first end of the corresponding holder has a mating member, preferably a screw, extending perpendicularly to the receiving plate, when the holder is placed properly. To connect the first end of the holder to the receiving plate, the mating member can be inserted in the hole of the receiving plate. The first end of the holder may be bifurcated, being a first furcation at one side of the corresponding receiving plate, a second furcation at the other side. However, in some cases, it can be more practical for the holder to be connected to only one side of the corresponding receiving plate, when located in the cavity.

For the purposes I stated above and in accordance with the invention, I suggest another connector and at least one holder, to be used with a plurality of bars and at least one framework component, in a supporting framework, the framework component, selected from a group, consisting of at least one cross brace, at least one panel and combinations thereof, the holder, having a first end and a second end, the first end, connected to the connector, the second end, connected to at least one of the framework components, the connector, comprising, a plurality of faces, each, adapted to be connected to one bar, the faces, located in a corresponding plurality of faces of an imaginary polyhedron, the connector further comprising an inner core and a plurality of projections, the inner core located in between the faces of the connector, each of the projections, projecting toward one of the faces, the inner core and the projections thereof, together, defining a plurality of cavities, inside the imaginary polyhedron, at each corner thereof, the connector, further comprising at least one bore on the inner core and the holder, further comprising at least one fixing member and at least one hole, the first end of the holder, located in one of the cavities, connected to the connector, by means of the fixing member, inserted through the hole on the holder into the bore of the inner core, the first end of the holder, being large enough to fill in the cavity substantially and comprising a mating face, adjusted to a surface portion of the connector, the surface portion, defining the cavity, the connector and the holder, characterized in that, when placed properly, the first end of the holder is encased in the cavity, in a way, stabilizing the second end thereof, in its final position and when the framework component applies a load to the second end of the holder, the mating face of the first end of the holder, is pressed to the surface portion of the connector, the surface portion, defining the cavity.

When a framework component is connected to the first end of the holder and when the framework component applies a load to the second end of the holder, the fixing member may be subjected only to forces that forces the mating face of the first end of the holder to dislocate. The fixing member can be elongated and the longitudinal axis of the fixing member can be parallel to an imaginary line, on which, the mating face moves while dislocation. The imaginary line advantageously passes through corner and centroid of the imaginary polyhedron. In cases, when the framework component is a cross-brace and the cross-brace applies a tensile force to the second end of the holder, the invention may be used to particular advantage and the fixing member can be subjected to a tensile force along the longitudinal axis thereof. Supporting only axial forces enables a fixing member to be used, conveniently, with a size, small enough to be located on the holder, without interfering the mating member at the second end of the holder without requiring an excessive elongation at the second end, an elongation that would serve as a lever arm which will increase the effect of the forces transmitted to the second end by the framework components.

The clearance between the fixing member and a first surface portion of the holder, defining the hole, in which, the fixing member is inserted, can be larger than the clearance between the mating face and a second surface portion of the connector, defining the corresponding cavity, in a way, preventing the fixing member from being subjected to the force applied by the framework component, in isolation.

Two holders can be connected to a connector, such that, the first ends thereof are located in two neighboring cavities and the second ends thereof are connected to the same framework component.

### 4. BRIEF DESCRIPTION OF DRAWINGS

FIG. 1a is a view of the connector in isolation.

FIG. 1b is a side elevation of the connector.

FIG. 2 is a perspective view of the holders connected to the connector; the holders adapted to hold glass panels.

FIG. 3 is a perspective view of the holders in detail; the holders adapted to hold panels.

FIG. 4 is an exploded perspective view of two holders, adapted to be connected to cross braces.

FIG. 5 is another perspective view of another type of holder adapted to hold panels.

FIG. 6 is a perspective view of holders in their connected position; the holders, with single furcation, adapted for connecting to cross braces.

FIG. 7 is a perspective view of holders that are connected to cross braces.

FIG. 8 is a detailed perspective view of a holder.

### 5. BEST MODES FOR CARRYING OUT THE INVENTION

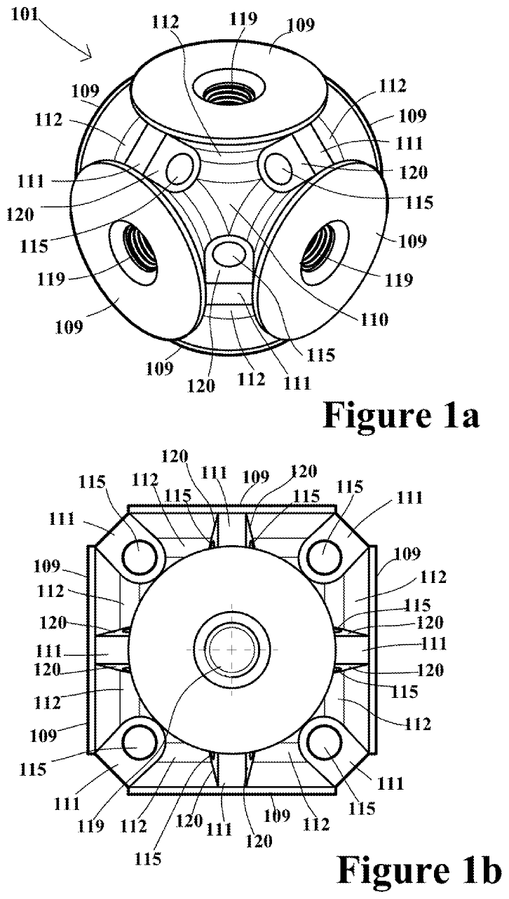

FIGS. 1a and 1b shows a connector 101, in the form of a polyhedron, preferably a cube. The connector 101 has faces 109 located in a corresponding plurality of faces of an imaginary polyhedron. The faces 109 are adapted to be connected to bars 103. The faces 109 have receiving members 119, usually in the form of threaded bores to connect to the bars 103. The connector 101 has an inner core 110 and receiving plates 111. The inner core 110 is located in between the faces 109 of the connector 101 and has projections 112, each projecting toward one of the faces 109. Each of the receiving plates 111, is located between an adjacent couple of the projections 112 of the inner core 110 and connected thereto. The receiving plates 111 lie parallel to an imaginary plane that passes through the longitudinal axis of each of the projections 112 of the adjacent couple thereof. The receiving plates 111 preferably has tapered surface 120 on the sides to provide stronger support for the projections 112 of the connector 101. The receiving plates 111, the inner core 110 and the projections 112 thereof, together, define cavities 114, inside the imaginary polyhedron, at each corner thereof.

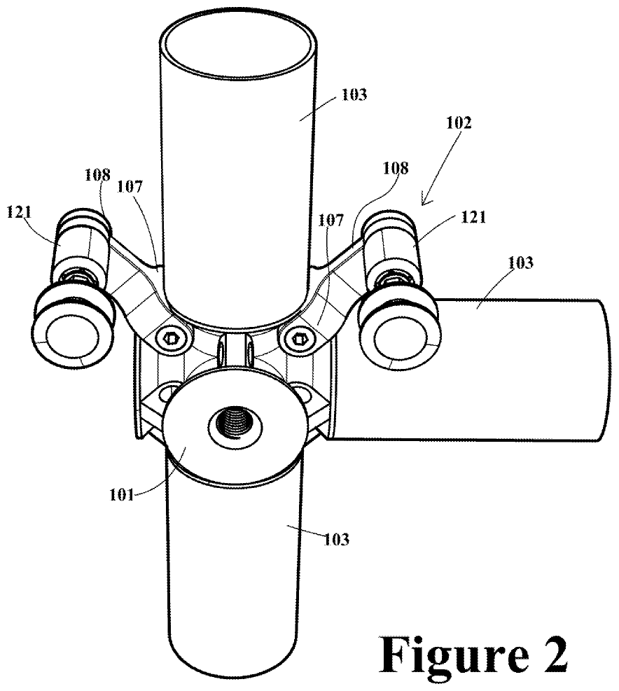

As shown in FIG. 2, the main function of the connector 101 is to connect to bars 103 and holders 102. The main function of the holders 102 can be construed as to hold framework components 104 including panels 106 and cross-braces 105 that will be shown in other figures. In FIG. 2 a glass panel holder 121 is shown. A holder 102 is an arm like component having a first 107 and a second end 108, the first end 107, connected to the connector 101, the second end 108, connected to at least one of the framework components 104. The first end 107 of the holder 102 is located in a cavity 114 and connected to the corresponding receiving plate 111.

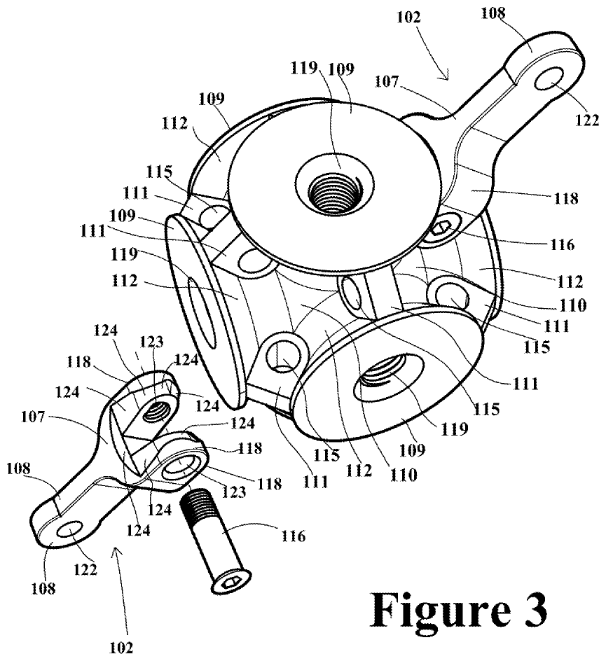

The connector 101 and the holder 102 are characterized in that, the first end 107 of the holder 102, is shaped so as to adjust to the corresponding portion of the cavity, as shown in FIG. 3, such that, when located properly, the first end 107 of the holder 102 is encased in the cavity 114, in a way, stabilizing the holder 102, in its final position. The first end 107 of the holder 102 has mating faces 124, shaped so as to adjust to a surface portion of the connector 101, the surface portion, defining the cavity 114 and any force acting on the framework component 104, is transmitted to the surface portion thereof and forces the first end 107 of the holder stay in place.

Each of the receiving plates 111 has holes 115 and the first end 107 of the corresponding holder 102 has a mating member 116, preferably a screw 117, extending perpendicularly to the receiving plate 111. To connect the first end 107 of the holder 102 to the receiving plate 111, the mating member 116 can be inserted in the hole 115 of the receiving plate 111.

The first end 107 of the holder 102 can be bifurcated as shown in FIG. 3, being a first furcation 118 at one side of the corresponding receiving plate 111, a second furcation 118 at the other side.

The first end 107 of the holder 102 can have holes 123 at each furcation 118, so that, the mating member 116 can be inserted through. The connection to the receiving plate 111 can be made by a nut to be fixed at the end of the screw 117 or one of the holes 123 can be threaded to receive the screw 117. The second end 108 of the holder 102 has also a hole 122 for connection of the framework components 104.

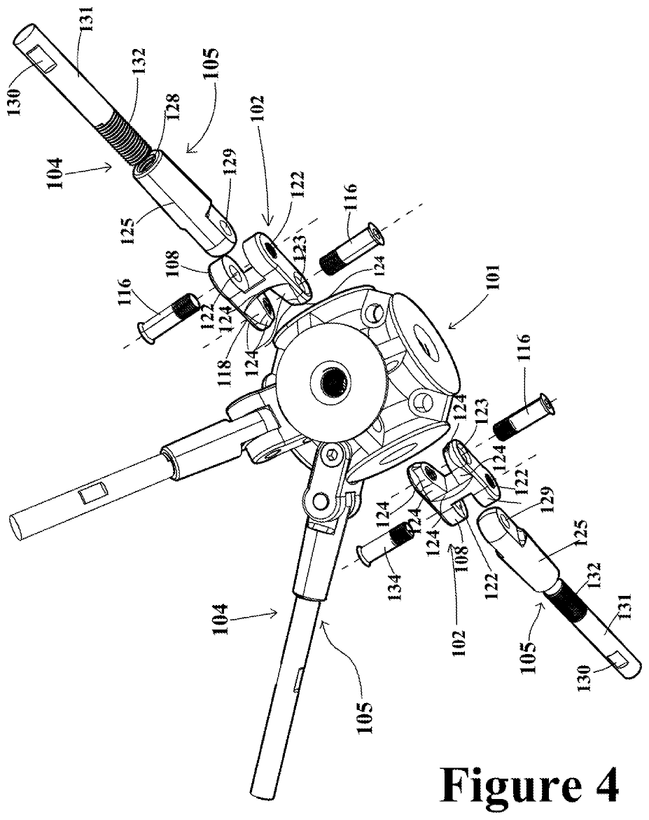

FIG. 4 shows a detailed and exploded perspective view of a holder 102 that is connected to a cross brace 105. As shown in the figure, the cavities 114 and holders 102 are shaped in relation to each other, such that, a holder 102 per each receiving plate 111 can be connected to a connector 101, concurrently. In cases that the holder 102 serves to hold cross braces 105, the second end 108 can be bifurcated, having holes 122 at each furcation 118 for a mating member 134 generally in the form of a screw, can be inserted through. The cross brace 105, as shown in FIG. 4, is basically consists a rod 131 and a rod holder 125. The rod holder 125 is a tube having threads inside at one end 127 and a bore 128 at the other end 126. The rod 131 has threads 132 at the end and preferably a notch 130 for an easy rotation, the rotation required for the threaded 132 end of the rod 131 to be fixed into the rod holder 125.

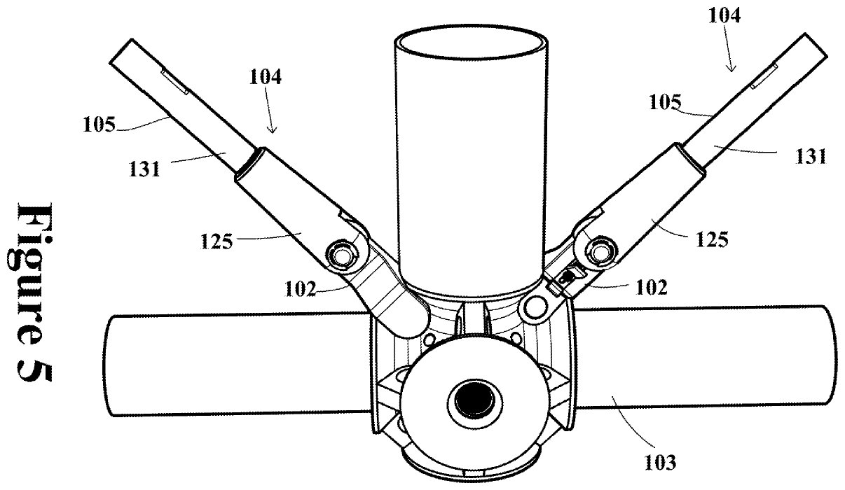

In some cases, it can be more practical for the holder 102 to be connected to only one side of the corresponding receiving plate 111, when located in the cavity 114, as shown in FIG. 5.

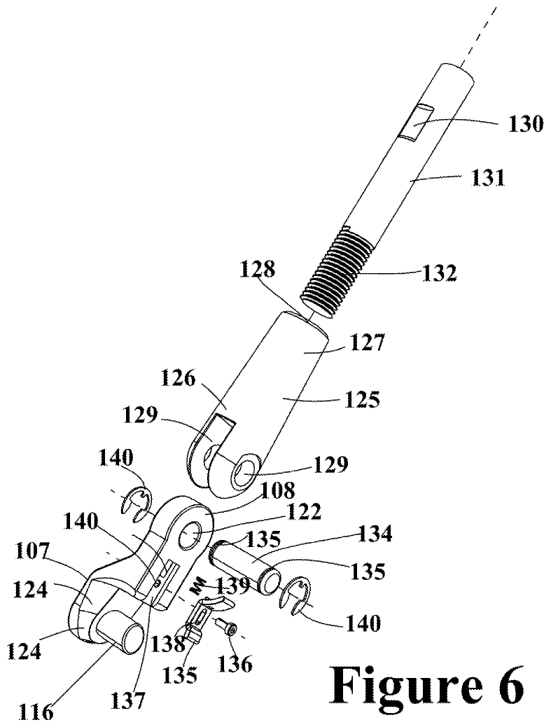

FIG. 6 shows a detailed view of a holder 102 which can be referred as a single furcated holder, intended to be used with a cross-brace 105 consisting of a rod 131 and a rod holder 125. In this version, the mating member 116 of the holder 102 is in the form of a simple protrusion that will be received by the hole 115 of the receiving plate 111 and retained therein. To prevent undesired dislocations, a safety mechanism, comprising a slider 135, a pin 136 and a spring 139, can be used. The slider 135 has an opening 138 thereon and the holder 102 has a slider channel 137 and a pin hole 141 therein. The pin 136 is inserted through the opening 138 and fixes the slider 135 to the holder 102 in a way that the slider 135 can move in the slider channel 137 on the longitudinal axis thereof. The spring 139 is located in the slider channel 137 and when extended the slider 135 extends toward the receiving plate 111 and prevents the holder 102 from moving at a direction perpendicular to the elongated axis of the mating member 116 of the first end 107 of the holder 102. A dismantling of the holder 102 can be made by retracting the slider 135 manually toward the other end of the slider channel 137.

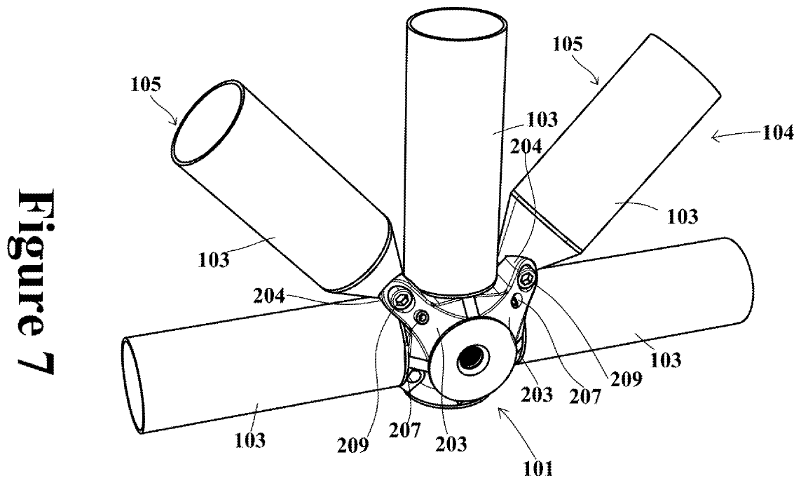

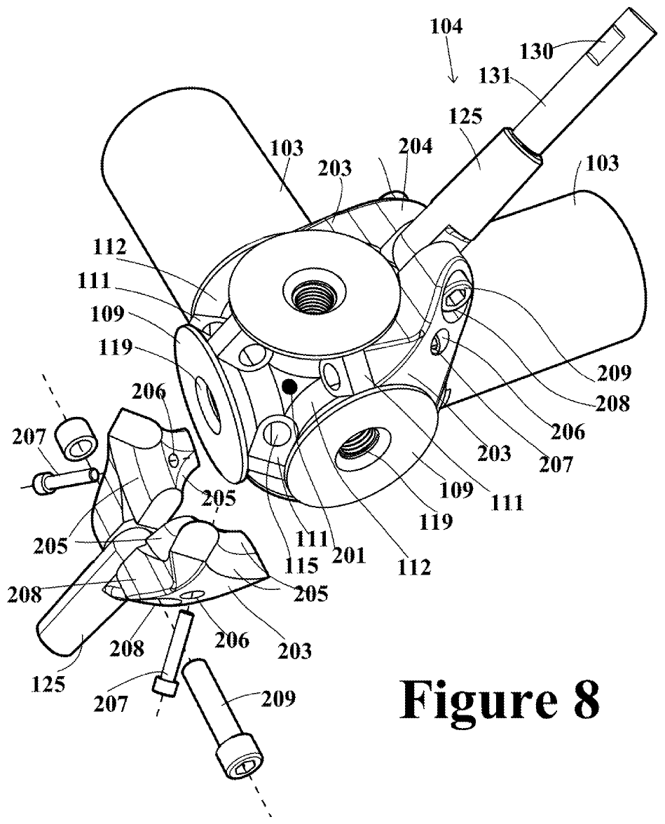

FIG. 7 and FIG. 8 shows another type of holder 202 with a connector 101 connected to bars 103. This type of holder 202 can also be connected to framework components 104, like cross-braces 105 and panels 106. The connector 101 is in the form of a polyhedron, preferably a cube. The connector 101 has faces 109 located in a corresponding plurality of faces of an imaginary polyhedron. The faces 109 are adapted to be connected to bars 103. The faces 109 have receiving members 119, usually in the form of threaded bores to connect to the bars 103. The connector 101 has an inner core 110, located in between the faces 109 thereof. The inner core has connection members 201 and projections 112, each of the projections, projecting toward one of the faces 109. The inner core 110 and the projections 112 thereof, together, define cavities 114, inside the imaginary polyhedron, at each corner thereof. The holder 102 has a first end 203 and a second end 204, the first end 203 is connected to the connector 101 and the second end 204 is connected to a framework component 104. The first end 203 of the holder 202 further comprises a fixing member 207 and a hole 206. The fixing member 207 is preferably a screw. The first end 203 of the holder 202 is located in one of the cavities 114, connected to the connector 101, by means of the fixing member 207, inserted through the hole 206 at the first end thereof into the bore 201 of the inner core 110. The first end 203 of the holder 202 is large enough to fill in the cavity 114 substantially and is shaped so as to adjust to the cavity 114 and when placed properly, the first end 203 of the holder 202 is encased in the cavity, in a way, stabilizing the holder 202, in its final position. The improved form of the holder 202 with the enlarged first end 203 makes the holder 202 stronger, which is advantageous especially for cases that the holder 202 is connected to cross-braces 105 which supports relatively large loads.

The first end 203 of the holder 202 has a mating face 205, adjusted to a surface portion of the connector 101, the surface portion, defining the cavity 114. In cases, when a framework component 104 is connected to the first end 203 of the holder 202, the fixing member 207, the mating face 205 of the first end 203 of the holder 202 and the surface portion, defining the cavity 114, can be shaped in relation with each other, such that, when the framework component 104 applies a load to the second end 204 of the holder 202, the mating face 205 of the first end 203 of the holder 202, is pressed to the surface portion of the connector 101, the surface portion, defining the cavity 114 and the fixing member 207 can be subjected only to forces that forces the mating face 205 of the first end 203 of the holder 202 to dislocate. The fixing member 207 can be elongated and the longitudinal axis of the fixing member 207 can be parallel to an imaginary line, on which, the mating face 205 moves while dislocation. The imaginary line advantageously passes through corner and centroid of the imaginary polyhedron. In cases, when the framework component 104 is a cross-brace 105 and the cross-brace 105 applies a tensile force to the second end 204 of the holder 202, the invention may be used to particular advantage and the fixing member 207 can be subjected to a tensile force along the longitudinal axis thereof. Supporting only axial forces enables a fixing member 207 to be used, conveniently, with a size, small enough to be located on the holder 202, without interfering the mating member 209 and the it is inserted 208 at the second end 204 of the holder 202 without requiring an excessive elongation at the second end 204, an elongation that would serve as a lever arm which will increase the effect of the forces transmitted to the second end 204 by the framework components 104.

The clearance between the fixing member 207 and a first surface portion of the holder 202, defining the hole 206, in which, the fixing member 207 is inserted, can be larger than the clearance between the mating face 205 and a second surface portion of the connector 101, defining the corresponding cavity 114, in a way, preventing the fixing member 207 from being subjected to the force applied by the framework component 104, in isolation.

Two holders 202 can be connected to a connector 101, such that, the first ends 203 thereof are located in two neighboring cavities 114 and the second ends 204 thereof are connected to the same framework component 104. This embodiment makes a stronger base especially for cross-braces 105 that support relatively higher tensional forces.

The cross braces 105 may be in the form of compression bars as shown in FIG. 7 or in the form of a rod 131 as shown in FIG. 8. The imaginary polyhedron is a cube in most cases and the bars 103 are mostly in cylindrical form.

### 6. INDUSTRIAL APPLICABILITY

The connectors and the holders can be produced with various forms of casting. Sand casting can be used economically for most cases. In cases when surface finish is important and high load bearing capacity is crucial, precision casting can be used to provide fine surface finish and to utilize any form of steel alloys. Bars and cross braces can be produced with conventional rolling and extrusion techniques, due to the material required for them.

1. A connector and at least one holder, to be used with a plurality of bars and at least one framework component, in a supporting framework, the framework component, selected from a group, consisting of at least one cross brace, at least one panel and combinations thereof, the holder, having a first end and a second end, the first end, connected to the connector, the second end, connected to at least one of the framework components, the connector, comprising, a plurality of faces, each adapted to be connected to one bar, the faces located in a corresponding plurality of faces of an imaginary polyhedron, the connector further comprising an inner core and a plurality of receiving plates, the inner core, located in between the faces of the connector, the inner core comprising projections, each projecting toward one of the faces, each of the receiving plates, located between an adjacent couple of the projections of the inner core and connected thereto, lying parallel to an imaginary plane that passes through the longitudinal axis of each of the projections of the adjacent couple thereof, and the receiving plates, the inner core and the projections thereof, together, defining cavities, inside the imaginary polyhedron, at each corner thereof, the first end of the holder, located in a cavity, connected to the corresponding receiving plate, the connector and the holder, characterized in that, the first end of the holder, is shaped so as to adjust to the corresponding portion of the cavity, such that, when located properly, the first end of the holder is encased in the cavity, in a way, stabilizing the second end thereof, in its final position.

2. The connector and at least one holder in accordance with claim 1, wherein, the cavities and the holders are shaped in relation with each other, such that, a holder per each receiving plate can be connected concurrently.

3. The connector and at least one holder in accordance with claim 1, wherein, at least one of the receiving plates comprises a hole and the first end of the corresponding holder comprises a mating member, extending perpendicularly to the receiving plate, when the holder is placed properly and to connect the first end of the holder to the receiving plate, the mating member is inserted in the hole of the receiving plate.

4. The connector and at least one holder in accordance with claim 1, wherein, the first end of the holder is bifurcated, being a first furcation at one side of the corresponding receiving plate, a second furcation at the other side thereof.

5. The connector and at least one holder in accordance with claim 1, wherein, the first end of the holder, when located in the cavity, is connected to only one side of the corresponding receiving plate.

6. The connector and at least one holder in accordance with claim 1, wherein, the mating member of the first end of the holder is a screw.

7. A connector and at least one holder, to be used with a plurality of bars and at least one framework component, in a supporting framework, the framework component, selected from a group, consisting of at least one cross brace, at least one panel and combinations thereof, the holder, having a first end and a second end, the first end, connected to the connector, the second end, connected to at least one of the framework components, the connector, comprising, a plurality of faces, each, adapted to be connected to one bar, the faces, located in a corresponding plurality of faces of an imaginary polyhedron, the connector, further comprising an inner core and a plurality of projections, the inner core located in between the faces of the connector, each of the projections, projecting toward one of the faces, the inner core and the projections thereof, together, defining a plurality of cavities, inside the imaginary polyhedron, at each corner thereof, the connector, further comprising at least one bore on the inner core and the holder, further comprising at least one fixing member and at least one hole, the first end of the holder, located in one of the cavities, connected to the connector, by means of the fixing member, inserted through the hole on the holder into the bore of the inner core, the first end of the holder, being large enough to fill in the cavity substantially and comprising a mating face, adjusted to a surface portion of the connector, the surface portion, defining the cavity, the connector and the holder, characterized in that, when placed properly, the first end of the holder is encased in the cavity, in a way, stabilizing the second end thereof, in its final position and when the framework component applies a load to the second end of the holder, the mating face of the first end of the holder, is pressed to the surface portion of the connector, the surface portion, defining the cavity.

8. The connector and at least one holder in accordance with claim 7, wherein, a framework component is connected to the first end of the holder and the mating face of the first end of the holder, corresponding cavity and the fixing member are shaped in relation with each other, such that, when the framework component applies a load to the second end of the holder, the fixing member is subjected only to forces that forces the mating face of the first end of the holder to dislocate.

9. The connector and at least one holder in accordance with claim 7, wherein, the fixing member is elongated and the longitudinal axis of the fixing member, is parallel to an imaginary line, on which, the mating face moves while dislocation.

10. The connector and at least one holder in accordance with claim 7, wherein, the framework component is a cross-brace and when the cross-brace applies a tensile force to the second end of the holder, the fixing member is subjected to a tensile force along the longitudinal axis thereof.

11. The connector and at least one holder in accordance with claim 9, wherein, the imaginary line passes through corner and centroid of the imaginary polyhedron.

12. The connector and at least one holder in accordance with claim 7, wherein, the clearance between the fixing member and a first surface portion of the holder, defining the hole, in which, the fixing member is inserted, is larger than the clearance between the mating face and a second surface portion of the connector, defining the corresponding cavity, in a way, preventing the fixing member from being subjected to the force applied by framework component, in isolation.

13. The connector and at least one holder in accordance with claim 7, wherein, two holders are connected to a connector, such that, the first ends thereof are located in two neighboring cavities and the second ends thereof are connected to the same framework component.

14. The connector and at least one holder in accordance with claim 1, wherein, the cross braces are in the form of a rod.

15. The connector and at least one holder in accordance with claim 1, wherein, at least one cylindrical bar is connected to the connectors.

16. The connector and at least one holder in accordance with claim 1, wherein, the imaginary polyhedron is a cube.

17. The connector and at least one holder in accordance claim 7, wherein, the fixing member is a screw.
